(19) United States
(12) Patent Application Publication
(10) Pub. No.: US 2026/0181445 A1
(43) Pub. Date: Jun. 25, 2026

(54) DEVICES, METHODS, APPARATUSES AND COMPUTER READABLE MEDIUM FOR COMMUNICATIONS

(71) Applicant: Nokia Technologies Oy, Espoo (FI)

(72) Inventors: Jing HE, Beijing (CN); Malgorzata TOMALA, Wroclaw (PL); Irina-Mihaela BALAN, Munich (DE); Ling YU, Espoo (FI)

(21) Appl. No.: 19/125,487

(22) PCT Filed: Nov. 4, 2022
(86) PCT No.: PCT/CN2022/130090

§ 371 Date: Apr. 29, 2025

(51) Int. Cl. H04W 24/10

(52) U.S. Cl. CPC H04W 24/10

(57) ABSTRACT

Embodiments of the present disclosure disclose devices, methods and apparatuses for a beam reporting. A first terminal device receives a channel quality threshold from a first network device. The terminal device determines whether a channel quality associated with a service is greater than or equal to the channel quality threshold. Then, based on determining that the channel quality level is greater than or equal to the channel quality threshold, the terminal device disables transmission of quality of experience, QoE, reporting data to the first network device. In this way, only the suitable terminal devices will transmit the QoE reporting data to the network.

### FIELD

Embodiments of the present disclosure generally relate to the field of communication, and in particular, to devices, methods, apparatuses and computer readable storage medium for communications.

### BACKGROUND

With the development of communication technology, the network is able to conditionally (for example, based on the communication status) schedule or adjust communication with a terminal device, in order to improve the quality of the communication. In turn, the terminal device may feedback information on the quality of the communication to the network, so that the network can be aware of the communication status.

Further, in some broadcast services (for example, multicast broadcast service, MBS) where the network transmits data for the service to a plurality of terminal device, the terminal device may also receive the data for the service in idle or inactive mode. However, certain communication quality feedback, for example, quality of experience (QoE) measurement, collection and reporting, is only enabled in the connected mode of the terminal device.

### SUMMARY

In general, example embodiments of the present disclosure provide devices, methods, apparatuses and computer readable storage medium for QoE reporting.

In a first aspect, there is provided a terminal device. The terminal device may comprise at least one processor; and at least one memory storing instructions that, when executed by the at least one processor, cause the terminal device to: receive a channel quality threshold from a first network device; and determine whether a channel quality level associated with a service is greater than or equal to the channel quality threshold. The terminal device is further caused to, based on determining that the channel quality level is greater than or equal to the channel quality threshold, disable transmission of QoE reporting data for the service to the first network device.

In a second aspect, there is provided a first network device. The first network device may comprise at least one processor; and at least one memory storing instructions that, when executed by the at least one processor, cause the first network device to: obtain a channel quality threshold for a terminal device to determine whether to disable transmission by the terminal device of QoE reporting data for a service; and transmit the channel quality threshold to the terminal device.

In a third aspect, there is provided a second network device. The second network device may comprise at least one processor; and at least one memory storing instructions that, when executed by the at least one processor, cause the second network device to: obtain a channel quality threshold for a terminal device to determine whether to disable transmission by the terminal device of QoE reporting data for a service; and transmit the channel quality threshold to a first network device.

In a fourth aspect, there is provided a method implemented at a terminal device. The method comprises: receiving, at a terminal device, a channel quality threshold from a first network device; determining whether a channel quality level associated with a service is greater than or equal to the channel quality threshold; and based on determining that the channel quality level is greater than or equal to the channel quality threshold, disabling transmission of QoE reporting data for the service to the first network device.

In a fifth aspect, there is provided a method implemented at a first network device. The method comprises: obtaining, at a first network device, a channel quality threshold for a terminal device to determine whether to disable transmission by the terminal device of QoE reporting data for a service; and transmitting the channel quality threshold to the terminal device.

In a sixth aspect, there is provided a method implemented at a second network device. The method comprises: obtaining, at a second network device, a channel quality threshold for a terminal device to determine whether to disable transmission by the terminal device of QoE reporting data for a service; and transmitting, to a first network device, the channel quality threshold.

In a seventh aspect, there is provided an apparatus of a terminal device. The apparatus comprises: means for receiving, at a terminal device, a channel quality threshold from a first network device; means for determining whether a channel quality level associated with a service is greater than or equal to the channel quality threshold; and means for, based on determining that the channel quality level is greater than or equal to the channel quality threshold, disabling transmission of QoE reporting data for the service to the first network device.

In an eighth aspect, there is provided an apparatus of a first network device. The apparatus comprises: means for obtaining a channel quality threshold for a terminal device to determine whether to disable transmission by the terminal device of QoE reporting data for a service; and means for transmitting the channel quality threshold to the terminal device.

In a ninth aspect, there is provided an apparatus of a second network device. The apparatus comprises: means for obtaining, at a second network device, a channel quality threshold for a terminal device to determine whether to disable transmission by the terminal device of QoE reporting data for a service; and means for transmitting the channel quality threshold to a first network device.

In an tenth aspect, there is provided a non-transitory computer readable medium comprising program instructions for causing an apparatus to perform at least the method according to any of fourth to sixth aspects.

In an eleventh aspect, there is provided a computer program comprising instructions, which, when executed by an apparatus, cause the apparatus at least to: receive a channel quality threshold from a first network device; and determine whether a channel quality level associated with a service is greater than or equal to the channel quality threshold. The terminal device is further caused to: based on determining that the channel quality level is greater than or equal to the channel quality threshold, disable transmission of QoE reporting data for a service to the first network device in that cell.

In an twelfth aspect, there is provided a computer program comprising instructions, which, when executed by an apparatus, cause the apparatus at least to: obtain a channel quality threshold for a terminal device to determine whether to disable transmission by the terminal device of QoE reporting data for a service; and transmit the channel quality threshold to the terminal device.

In an thirteenth aspect, there is provided a computer program comprising instructions, which, when executed by an apparatus, cause the apparatus at least to: obtain a channel quality threshold for a terminal device to determine whether to disable transmission by the terminal device of QoE reporting data for a service; and transmit the channel quality threshold to a first network device.

In a fourteenth aspect, there is provided a terminal device. The terminal device comprises receiving circuitry configured to: receive a channel quality threshold from a first network device; determining circuitry configured to determine whether a channel quality level associated with a service is greater than or equal to the channel quality threshold; and transmit circuitry configured to, based on determining that the channel quality level is greater than or equal to the channel quality threshold, disable transmission of QoE reporting data for the service to the first network device.

In a fifteenth aspect, there is provided a first network device. The first network device comprises obtaining circuitry configured to obtain a channel quality threshold for a terminal device to determine whether to disable transmission by the terminal device of QoE reporting data for a service; and transmit circuitry configured to transmit the channel quality threshold to the terminal device.

In a sixteenth aspect, there is provided a second network device. The second network device comprises obtaining circuitry configured to obtain a channel quality threshold for a terminal device to determine whether to disable transmission by the terminal device of QoE reporting data for a service; and transmit circuitry configured to transmit the channel quality threshold to the first network device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates an example signaling process for QoE reporting according to some embodiments of the present disclosure;

FIG. 3 illustrates another example process implemented at the terminal device according to some embodiments of the present disclosure;

FIG. 4 illustrates flowchart of a method implemented at a terminal device according to example embodiments of the present disclosure;

FIG. 5 illustrates an example flowchart of a method implemented at a first network device according to example embodiments of the present disclosure;

FIG. 6 illustrates an example flowchart of a method implemented at a second network device according to example embodiments of the present disclosure;

FIG. 7 illustrates an example simplified block diagram of an apparatus that is suitable for implementing embodiments of the present disclosure; and

FIG. 8 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, 5G-A, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, certain communication quality feedback, for example, quality of experience (QoE) measurement, collection and reporting, is only enabled in the connected mode of the terminal device. Specifically, in multicast broadcast services (MBS), which is a new service in 5G defined in Rel-17, MBS (which may also be called MBMS or eMBMS) have been considered to allow for resource efficient transmission towards multiple end users which require receiving same service contents. Since broadcasting is spreading information only in downlink (DL), it can be even received by a terminal device in RRC idle mode or RRC inactive mode. That is, all terminal devices in the broadcast service area are authorized to receive the data. On the other hand, 3GPP has started to study New Radio (NR) QoE management and optimizations for diverse services, in order to identify a framework for collecting and reporting of NR QoE measurement and to study the potential impact on the related RAN interfaces. The activation procedure of QoE measurement collection (QMC) is described, and the activation procedure is used to initiate one or more QMC jobs at the terminal device. A “QoE reference ID” is used to uniquely identify one QMC job.

Moreover, 3GPP Rel-17 standardized NR QoE supporting the Application Layer Measurement Collection functionality is only for RRC connected mode. Rel-17 also supports RAN-Visible (RV) QoE to RRC connected UEs, where a subset of legacy QoE metrics collected from the terminal device is used by RAN for further optimizations. Apart from these RV-QoE measurements, RAN may not be able to understand or make use of the legacy QoE metrics, as they are assembled by an operation administration and maintenance (OAM) entity, sent inside containers and intended to be processed by a measurement collection entity (MCE) in the network. RAN-visible QoE information is specific QoE information derived from QoE metrics, which the RAN may use for various types of optimizations. A “measConfigAppLayerId” is defined in RRC message to uniquely identify one QMC job with mapping to “QoE reference ID”. However, the QoE reporting associated with the mode of the terminal device (for example, RRC idle, RRC inactive or RRC connected mode), or which terminal device in idle and inactive should perform the QoE reporting is not considered or designed yet.

For improving the communication quality timely, it is expected that the terminal device would be able to make QoE measurements during RRC idle/inactive states and report QoE measurements when returning back to RRC connected state. For example, in some cases, MBS service is transmitted in air interface in a Point-to-Multiple-Point way, PDSCH/PDCCH is to carry MBS traffic channel (MTCH)/MBS control channel (MCCH) data for MBS service data transmission. MBS terminal device may use g-radio network temporary identification (RNTI) (group RNTI) to scramble the scheduling and transmission of MTCH. When entering idle/inactive mode, MBS terminal device receives MBS service and moves freely, and therefore terminal device's location is unknown by the network on cell level, for example, in which cell or where is it in one cell. At network side, there is a need for a network-controlled solution for the QoE reporting.

In one solution, all idle/inactive MBS terminal devices who have received QoE measurement configuration will perform QoE measurement and report QoE reporting data to the network. As such (all terminal devices will report), it will bring high uplink signaling load to air interface. Moreover, it is not necessary to let all idle/inactive MBS terminal devices to do QoE measurement, those MBS terminal devices which has good or excellent user experience doesn't need to report its QoE measurement result, because reporting of good experience can't help operator to optimize relative MBS service and just waists radio resource on the air interface. Only suitable terminal devices should be determined and configured with QoE measurement configuration and then their QoE reports will support operator to improve network performance.

In another solution, the network randomly selects some of terminal devices to configure QoE measurement configuration, for example, via the RRCReconfiguration or RRCRelease message, when the terminal device is in RRC connected mode or transferred from RRC connected mode to RRC idle/inactive mode. It can avoid lots of terminal devices reporting as well high uplink signaling load occurring, but it is of no help on terminal devices actually required to perform QoE reporting, since network will not know the location of selected terminal devices after the terminal devices enters idle/inactive mode.

At least for solving the above issues and improving the performance of a communication system, a scheme for QoE reporting is provided. In this scheme, a terminal device receives a channel quality threshold from a first network device, and the channel quality threshold can be used by the terminal device to determine whether to transmit QoE reporting data to the first network device. The terminal device determines whether a channel quality level associated with a service is greater than or equal to the channel quality threshold. Then, the terminal device disables a transmission of QoE reporting data to the first network device if it is determined that the channel quality level is greater than or equal to the channel quality threshold. In some examples, the QoE reporting data may be collected in the idle mode or the inactive mode of the terminal device.

In this way, only the suitable terminal devices (for example, the terminal devices experiencing poor communication conditions and the network device is not aware of the location of the terminal device since the terminal device is in idle or inactive mode) will transmit the QoE reporting data to the network. As such, the uplink signaling overload can be avoided, and the network may improve the performance of the communication system efficiently by scheduling resources for the terminal devices reporting QoE measurements.

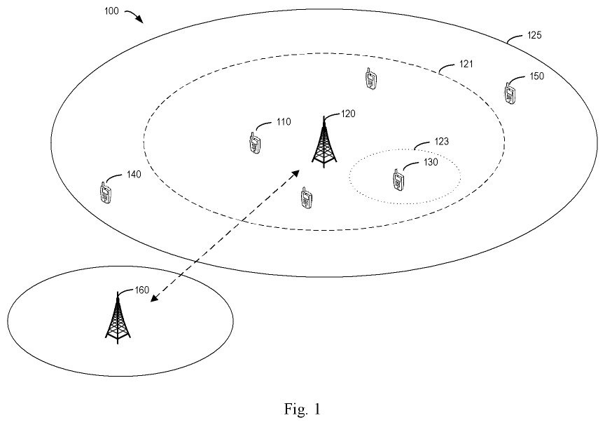

Principle and embodiments of the present disclosure will be described in detail below with reference to the accompanying drawings. FIG. 1 illustrates an example network environment 100 in which example embodiments of the present disclosure may be implemented. The environment 100, which may be a part of a communication network, includes terminal devices and network devices.

As illustrated in FIG. 1, the network environment 100 may include terminal device 110, a first network device 120, other terminal devices 130, 140 and 150, and a second network device 160. Just for sake of discussion and without any limitation, the cell 125 is the serving cell for the terminal devices 110, 130, 140 and 150, and the cell 125 is provided and operated by the first network device 120. The coverage area 121 is the area where the terminal device may be provided with good communication environment, and the area between the coverage area 121 and the coverage area of the serving cell 125 is the edge of the serving cell 125. The terminal devices located within the area between the coverage 121 and the area of the serving cell 125 may experience poor communication environment (for example, having poor MBS service quality). In addition, only as an example, the coverage area 123 represents a coverage hole in the cell 125, the coverage hole 123 may be caused by the signal being blocked by, for example a high building. Further, the first network device 120 and the second network device 160 may communicate with each other, for example via an Xn interface.

In this disclosure, idle/inactive MBS terminal devices that are suffering worse MBS service quality may perform QoE measurement and reporting, which is caused by the terminal device of which current location doesn't have good MBS service quality, for example, at the cell edge which MBS service coverage doesn't properly cover, or at a coverage hole. Actually, only such terminal device's QoE reporting can help operator to optimize its network and service quality. As shown in FIG. 1, the terminal devices 130, 140 and 150 may be required to perform QoE measurements and to transmit QoE reporting data.

It is to be understood that the number of network devices and terminal devices is given only for the purpose of illustration without suggesting any limitations. The system 100 may include any suitable number of network devices and/or terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G), the fifth generation (5G), 5G-Advanced or beyond (6G), wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

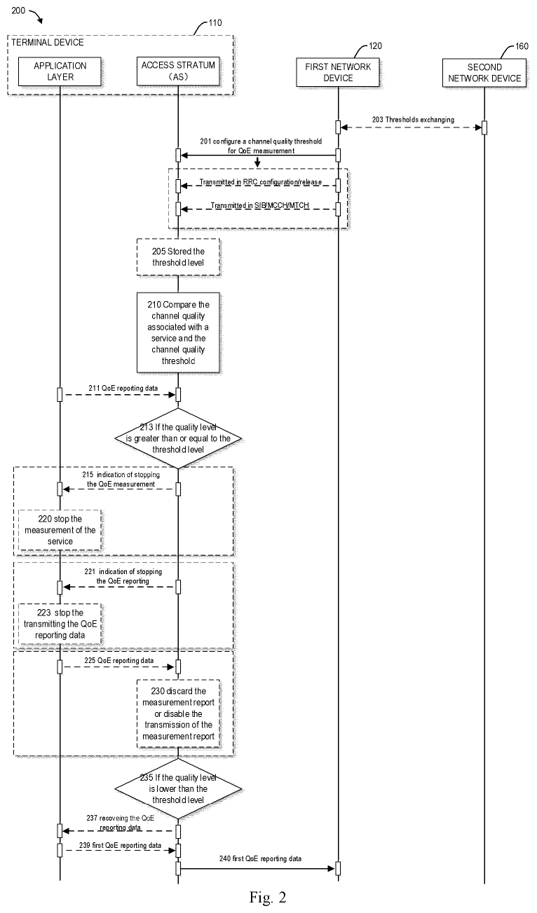

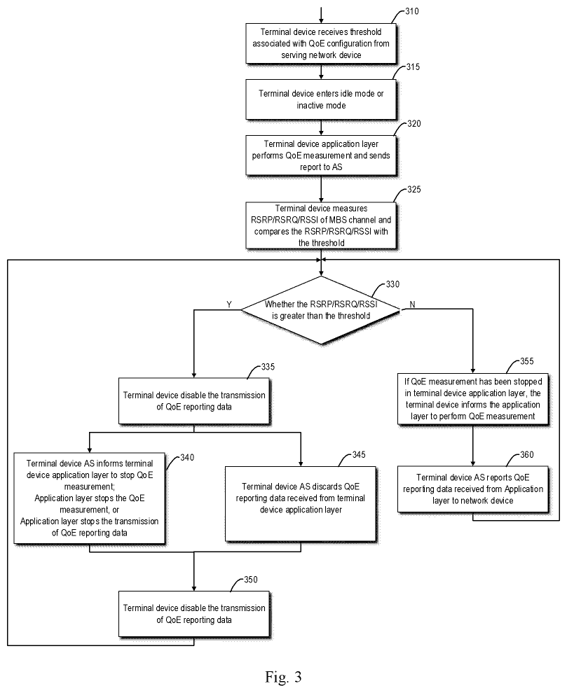

In this disclosure, QoE reporting procedure is proposed, and the embodiments are further discussed with reference to FIGS. 2 and 3.

FIG. 2 illustrates an example signaling process 200 for QoE reporting according to some embodiments of the present disclosure. For the purpose of discussion, the process 200 will be described with reference to FIG. 1. It would be appreciated that although the process 200 has been described in the communication environment 100 of FIG. 1, this process 200 may be likewise applied to other communication scenarios.

In the signaling 200, the terminal devices 110, 130, 140 and/or 150 receive (201) a channel quality threshold from a first network device. The channel quality threshold may be used by the terminal devices to determine whether to disable transmission by the terminal devices of QoE reporting data for a service to the first network device 120. In some embodiments, the channel quality threshold may be a threshold value for at least one of: Reference Signal Receiving Power (RSRP) or Reference Signal Receiving Quality (RSRQ) of a reference signal associated with a service (for example, MBS service), or Received Signal Strength Indicator (RSSI) of a signal associated with the service.

In some embodiments, the first network device 120 may broadcast the channel quality threshold to the terminal devices. Alternatively, the first network device 120 may transmit the channel quality threshold to the terminal devices, separately. In some embodiments, the channel quality threshold may be transmitted in at least one of: RRC dedicated signaling, broadcast signaling, MBS traffic channel, MTCH, and MBS control channel, MCCH. Without any limitation, the following embodiments may be discussed with reference to the terminal device 110. For example, the channel quality threshold may be configured to the terminal device 110 by RRC dedicated signaling in RRC (re)configuration procedure or RRC connection release procedure, or by broadcast signaling via System Information Blocks (SIB), or via MCCH/MTCH. In turn, the terminal device 110 may receive the channel quality threshold via the Access Stratum of the terminal device 110.

In some embodiments, the network device 120 may configure (201) a plurality of thresholds (for example, the channel quality thresholds as mentioned above) to the terminal devices, and the above channel quality threshold is one of the plurality of thresholds. In an example, a channel quality threshold of the plurality of channel quality thresholds is specific to the serving cell 125, and at least one other channel quality threshold of the plurality of channel quality thresholds is specific to at least one respective neighbor cell, for example, the cell provided by the second network device 160. As such, the network may configure the terminal device 110 with at least one threshold for the serving cell 125 and with a list of thresholds for one or more neighbor cells, or the terminal devices who are capable to support QoE measurement in idle/inactive mode.

In addition or alternatively, a channel quality threshold of the plurality of channel quality thresholds may be configured for the idle mode of the terminal device 110, and another channel quality threshold of the plurality of channel quality thresholds may be configured for the inactive mode the terminal device 110. In this way, the threshold can be set separately for idle UEs or inactive UEs. In addition or alternatively, the threshold in the plurality of threshold may be also specific to a certain terminal device. In addition or alternatively, a channel quality threshold of the plurality of channel quality thresholds is configured for at least one measurement configuration (for example, QoE measurement configuration), and the at least one measurement configuration is associated with at least one respective service. In an example, the threshold can be one-to-one configured to each QoE measurement configuration or one-to-multiple configured to multiple QoE measurement configurations. In some embodiments, the channel quality threshold may be transmitted with the corresponding QoE measurement configuration, for example QoE configuration container. In an example, the QoE measurement configuration may be uniquely identified by “AppMeasID”. Alternatively, the channel quality threshold and the corresponding QoE measurement configuration may be also transmitted separately.

Furthermore, as mentioned above, the first network device 120 may configure the terminal device 110 with a list of thresholds, and the list of thresholds comprises the thresholds specific to neighboring cells. In this case, the network devices may exchange (203) the thresholds with each other, for example via an Xn interface. In some embodiments, the first network device 120 may receive from the second device 160 the thresholds associated with cells provided by the second network device 160, for example the channel quality threshold specific to the cell provided by the second network device 160. In addition, the first network device 120 may request the channel quality thresholds from the second network device 160, for example, by transmitting a request for the thresholds to the second network device 160. In turn, upon receiving the request, the second network device 160 may transmit the respective channel quality thresholds to the first network device 120. In some embodiments, the first network device 120 and the second network device 160 may obtain the respective channel quality thresholds by themselves. For example, the first network device 120 or the second network device 160 may determine the respective channel quality thresholds based on statistic data obtained from a MCE. Alternatively, the channel quality thresholds may be set by an OAM entity. In turn, the first and second network devices 120 and 160 may obtain the respective thresholds from the OAM entity.

If the terminal device 110 receives the plurality of thresholds including the threshold specific to the serving cell (for example, cell 125) and other thresholds specific to the neighboring cells (for example, cell provided by the second network device 160), the terminal device 110 may adopt at least one threshold of a current camped cell or a serving cell 125 of the terminal device 110. In the case that the terminal device 110 moves from the cell 125 to another cell provided by the second network device 160, the terminal device 110 may adopt a threshold of the cell provided by the second network device 160 (as mentioned above, the threshold is also included in the plurality of thresholds received from the first network device 120) for the subsequent operations. In other words, the channel quality threshold is determined specifically for the respective cell, and the terminal devices covered, camped in, or served by the respective cell should use this channel quality threshold. Upon changing the camping or serving cell of the terminal device, the channel quality threshold adopted by the terminal device 110 may be changed accordingly. In some embodiments, the channel quality threshold may be identified by a cell identifier for the respective cell, such as a global or physical cell identifier. In some other embodiments, the channel quality threshold may be associated with the respective cell in any other manners.

Still Referring to FIG. 2, upon receiving the channel quality threshold (or the list of thresholds as mentioned above), the first terminal device 110 may store (205) the channel quality threshold for the terminal device 110 to determine whether to perform the QoE measurement and transmit the QoE reporting data in different operation modes, such as the RRC idle mode, the RRC inactive mode or the RRC connected mode.

Then, the terminal device 110 determines (210) whether a channel quality level associated with a service is greater than or equal to the channel quality threshold. For example, the terminal device 110 compares between the measured channel quality level and the channel quality threshold. In some embodiments, the service may be a Multicast Broadcast Service, MBS. In this case, the channel quality level associated with the service may be determined by measuring a Reference Signal (RS) for the MBS. In turn, the channel quality level may be a value of Reference Signal Receiving Power, RSRP, Reference Signal Receiving Quality, RSRQ, or a Received Signal Strength Indicator, RSSI. In an example, at AS, the terminal device 110 in idle/inactive mode may measure the RSRP/RSRQ of PDSCH/PDCCH that is carrying MBS service (MTCH/MCCH). In some embodiments, the application layer of the terminal device 110 may transmit the QoE reporting data for determining whether a channel quality level associated with a service is greater than or equal to the channel quality threshold. In turn, the terminal device 110 receives (211) the QoE reporting data at AS. In some other embodiments, the terminal device 110 may also directly measure the channel quality level.

In some embodiments, the terminal device 110 may determine whether a channel quality level associated with a service is greater than or equal to the channel quality threshold in the idle mode or inactive mode. Alternatively, the terminal device 110 may also determine whether a channel quality level associated with a service is greater than or equal to the channel quality threshold in the connected mode.

At 213, if the channel quality level is greater than or equal to the channel quality threshold, the terminal device 110 disables (215, 220, 223, or 230) the transmission of the QoE reporting data for the service to the first network device 120. The QoE reporting data is obtained by performing a QoE measurement on the service. Regarding the disabling of the transmission of the QoE reporting data, there may be several handling manners. In some embodiments, the terminal device 110 may transmit (215), from AS of the terminal device 110 to an application layer of the terminal device 110, an indication that is indicative of stopping the QoE measurement of the service. In turn, at the application layer, the terminal device 110 may stop (220) the QoE measurement of the service upon receiving (215) this indication. In this way, the terminal device 110 may completely disable the measurement of the service, and the transmission of the QoE reporting data is disabled accordingly. As such, the measurement resource can be saved. Alternatively, at the application layer, the terminal device 110 may perform the measurement of the service continuously. Further, the application layer of the terminal device 110 may stop (220) transmitting the QoE reporting data to the Access Stratum (AS) of the terminal device 110, based on receiving the indication that is indicative of stopping the measurement of the service from AS.

In addition or alternatively, the terminal device 110 may further transmit (221), from AS of the terminal device 110 to the application layer of the terminal device 110, another indication that is indicative of stopping the QoE reporting of the service. In turn, based on receiving the other indication, the application layer may stop (220) transmitting the QoE reporting data to the AS. In this way, the measurement of the service is performed continuously, and the QoE reporting data can be transmitted timely if the channel quality level is no longer greater than or equal to the channel quality threshold. Furthermore, the signaling exchange within the terminal device 110 can be decreased.

Alternatively, the terminal device 110 may transmit no indication from AS of the terminal device 110 to the application layer of the terminal device 110. At the application layer, the terminal device 110 may perform the measurement of the service continuously, and transmit (225) the QoE reporting data to the AS. In turn, at the AS, the terminal device 110 may discard (230) the QoE reporting data received (225) from the application layer. In this way, the terminal device 110 doesn't need signaling exchanges within the terminal device 110 and may re-transmit the QoE reporting data to the second network device 160 as soon as possible, if the channel quality level is no longer greater than or equal to the channel quality threshold.

At 235, if the channel quality level is lower than the channel quality threshold, the terminal device 110 may perform a QoE measurement on the service to obtain the QoE reporting data, and transmit (240) the QoE reporting data to the first network device 120. Alternatively, if the channel quality level is lower than the channel quality threshold and the application layer has stopped the QoE measurement, the terminal device 110 may transmit (237) an indication that is indicative of resuming the QoE reporting of the service from the AS to the application layer. Then, the application layer may resume performance of QoE measurement (which may be also referred to as the first QoE measurement in this disclosure) on the service to obtain the QoE reporting data, and transmit (239) the QoE reporting data (which may be also referred to as the first QoE reporting data) to the first network device 120. In some embodiments, as mentioned above, the application may perform the QoE measurement continuously and only stop the transmission of the QoE reporting data. In this case, upon receiving (237) the indication that is indicative of recovering the QoE reporting of the service, the application may recover (239) the transmission of the first QoE reporting data directly. Further, the terminal device 110 may perform the QoE measurement in application layer, and transmit (240) the first QoE reporting data to the network via AS. In turn, the first network device 120 may adjust the communication resource for the terminal device 110 based on receiving (240) the QoE reporting data. In some embodiments, even if the terminal device 110 has entered the idle or inactive mode, the terminal device 110 still performs the QoE measurement on the service to obtain the QoE reporting data if the channel quality level is lower than the channel quality threshold. Then, the terminal device 110 may transmit these QoE reporting data to the first network device 120 when the terminal device 110 enters the connected mode.

In this way, the above channel quality threshold configured by the first network device 120 may act as an enabling indication. If the terminal device 110 receives the channel quality threshold, the terminal device 110 may perform the actions as shown in FIG. 2 during the terminal device 110 is in the idle mode or the inactive mode. That is, the terminal device 110 may enable QoE measurement configuration to perform the QoE measurement based on receiving the channel quality threshold for the service in the idle mode or the inactive mode.

As mentioned above, the disclosure proposes a method that only those MBS terminal devices in idle/inactive mode who have QoE measurement configuration but have potential to have poor MBS service experience are selected to perform QoE measurement in application layer and report QoE reporting data to the network via AS layer when its RRC status allows to send the report. In this way, the uplink signaling load can be significantly decreased and the performance of the network can be improved.

FIG. 3 illustrates another example process implemented at the terminal device according to some embodiments of the present disclosure.

When the terminal device having the QoE measurement configuration enters idle/inactive mode and the channel quality threshold is configured, the terminal device behavior is shown by FIG. 3. For the purpose of discussion, the process shown in FIG. 3 will be described with reference to FIG. 1.

At 310, the terminal device 110 receives threshold associated with QoE configuration from the serving network device 120. At 315, the terminal device 110 enters the idle mode or inactive mode. At 320, the terminal device 110 performs QoE measurement at application layer and transmits the QoE reporting data from the application layer to the AS. At 325, the terminal device 110 measures RSRP/RSRQ/RSSI of MBS channel and compares the measured RSRP/RSRQ/RSSI with the threshold. At 330, the terminal device 110 determines whether the RSRP/RSRQ/RSSI is greater than or equal to the threshold. If the RSRP/RSRQ/RSSI is greater than or equal to the threshold, at 335, the terminal device disables the transmission of the QoE reporting data. For disabling the transmission of the QoE reporting data, at 340, the AS of the terminal device 110 informs the application layer of the terminal device 110 to stop QoE measurement or stop QoE reporting. Then, at 340, the terminal device 110 may stop the QoE measurement at the application layer directly, or perform the QoE measurement continuously and stop the transmission of QoE reporting data to the AS. Alternatively, at 345, the terminal device 110 discards the QoE reporting data at the AS. At 350, the terminal device 110 disables the transmission of QoE reporting data. In turn, the flowchart proceeds back to the block 330. Block 330 may be performed periodically.

Further, if the QoE measurement has been stopped in the application layer and the RSRP/RSRQ/RSSI is lower than the threshold, at 355, the terminal device 110 may inform the application layer to perform QoE measurement. At 360, the AS of the terminal device 110 reports QoE reporting data to the network device 120. In turn, the flowchart proceeds back to the block 330. Block 330 may be performed periodically.

In this way, the new network-controlled solution according to the embodiments of the disclosure at least can solve the issue regarding which terminal devices are selected to report the QoE reporting data. Further, the solution can avoid unnecessary QoE reporting in air interface from any UE who has good MBS service experience, and finally it will reduce signaling load and save air interface resource. Moreover, the solution selects some of UEs who are suffering worse MBS service experience to provide useful QoE reporting to network. Such QoE reporting data can help operator to optimize its network and service quality.

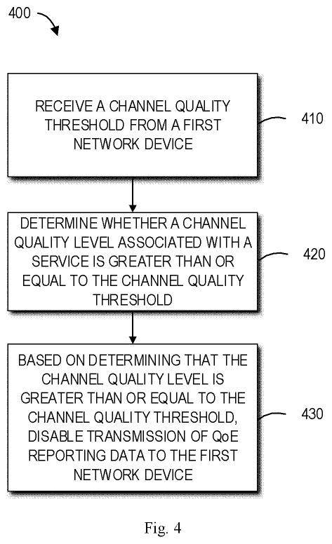

FIG. 4 shows a flowchart of an example method 400 implemented at a terminal device (for example, the terminal device 110) in accordance with some embodiments of the present disclosure. For the purpose of discussion, the method 400 will be described from the perspective of the terminal device 110 with reference to FIG. 1.

At 410, the terminal device 110 receives a channel quality threshold from a first network device 120. At 420, the terminal device 110 determines whether a channel quality level associated with a service is greater than or equal to the channel quality threshold. At 430, based on determining that the channel quality level is greater than or equal to the channel quality threshold, the terminal device 110 disables transmission of QoE reporting data for the service to the first network device 120.

In some embodiments, further comprising: based on determining that the channel quality level is lower than the channel quality threshold, the terminal device 110 may perform first QoE measurement for the service to obtain first QoE reporting data; and transmit the first QoE reporting data to the first network device 120.

In some embodiments, at least one of the following is performed in an idle mode or an inactive mode of the terminal device 110: the terminal device 110 may determine whether the channel quality level associated with the service is greater than or equal to the channel quality threshold; the terminal device 110 may disable transmission of QoE reporting data for the service to the first network device 120; and the terminal device 110 may perform the first QoE measurement.

In some embodiments, the method further comprises the terminal device 110 transmitting the first QoE reporting data in a connected mode of the terminal device via an access stratum of the terminal device 110.

In some embodiments, the service is a Multicast Broadcast Service, MBS.

In some embodiments, the terminal device 110 may disable the transmission of the QoE reporting data for the service by: transmitting, from an access stratum of the terminal device 110 to an application layer of the terminal device 110, an indication that is indicative of stopping QoE measurement for the service at the application layer, or that is indicative of stopping transmission of QoE reporting data for the service from the application layer to the access stratum.

In some embodiments, the terminal device 110 may disable the transmission of QoE reporting data for the service by at least one of: stopping, at the application layer of the terminal device 110, QoE measurement for the service based on receiving, from the access stratum of the terminal device 110, the indication that is indicative of stopping QoE measurement for the service; or performing, at the application layer, QoE measurement for the service and stopping transmitting QoE reporting data for the service from the application layer to the access stratum based on receiving, from the access stratum, the indication that is indicative of stopping transmission of QoE reporting data for the service.

In some embodiments, the method further comprises the terminal device 110 may perform QoE measurement for the service in an application layer of the terminal device 110, and to transmit QoE reporting data from the application layer to an access stratum of the terminal device 110, and wherein the terminal device 110 is further caused to disable the transmission of QoE reporting data for the service by discarding, at the access stratum, QoE reporting data for the service received from the application layer.

In some embodiments, the channel quality threshold is one of a plurality of channel quality thresholds received from the first network device 120. In some embodiments, a channel quality threshold of the plurality of channel quality thresholds is specific to a serving or camping cell of the terminal device 110, and at least one other channel quality threshold of the plurality of channel quality thresholds is specific to at least one respective neighbor cell.

In some embodiments, a channel quality threshold of the plurality of channel quality thresholds is configured for at least one measurement configuration, the at least one measurement configuration being associated with at least one respective service.

In some embodiments, a channel quality threshold of the plurality of channel quality thresholds is configured for the idle mode, and wherein another channel quality threshold of the plurality of channel quality thresholds is configured for the inactive mode.

In some embodiments, the channel quality level is determined based on a reference signal transmitted in Physical Downlink Shared Channel or Physical Downlink Control Channel that carries the service, and wherein the channel quality level comprises at least one of Reference Signal Receiving Power, RSRP, Reference Signal Receiving Quality, RSRQ, or Received Signal Strength Indicator, RSSI.

In some embodiments, the terminal device 110 may receive the channel quality threshold in at least one of: RRC dedicated signaling; broadcast signaling; MBS traffic channel, MTCH; or MBS control channel, MCCH.

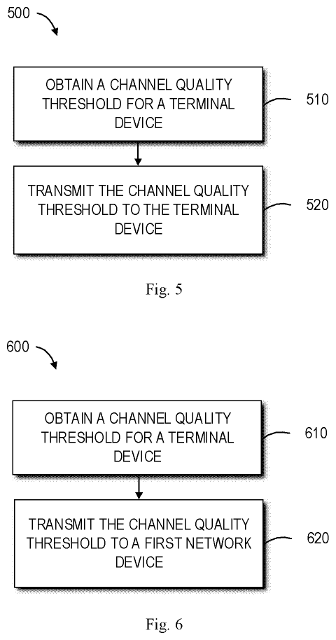

FIG. 5 shows a flowchart of an example method 500 implemented at a network device (for example, the first network device 120) in accordance with some embodiments of the present disclosure. For the purpose of discussion, the method 500 will be described from the perspective of the first network device 120 with reference to FIG. 1.

At 510, the first network device 120 obtains a channel quality threshold for a terminal device 110 to determine whether to disable transmission by the terminal device 110 of QoE reporting data for a service. At 520, the first network device 120 transmits the channel quality threshold to the terminal device 110.

In some embodiments, the service is a Multicast Broadcast Service, MBS. In some embodiments, the channel quality threshold is one of a plurality of channel quality thresholds transmitted to the terminal device 110. In some embodiments, a channel quality threshold of the plurality of channel quality thresholds is specific to a serving or camping cell of the terminal device 110, and at least one other channel quality threshold of the plurality of channel quality thresholds is specific to at least one respective neighbor cell. In some embodiments, the first network device 120 is further caused to receive the at least one other channel quality threshold from a second network device.

In some embodiments, a channel quality threshold of the plurality of channel quality thresholds is configured for at least one measurement configuration, the at least one measurement configuration being associated with at least one respective service.

In some embodiments, a channel quality threshold of the plurality of channel quality thresholds is configured for an RRC idle mode of the terminal device 110, and wherein another channel quality threshold of the channel quality plurality of thresholds is configured for an RRC inactive mode of the terminal device 110.

In some embodiments, the first network device 120 may obtain a channel quality threshold by receiving the channel quality threshold from an Operation Administration and Maintenance, OAM, entity.

In some embodiments, the first network device 120 may obtain a channel quality threshold by determining the channel quality threshold based on statistic information received from Measurement Collection Entit, MCE.

In some embodiments, the first network device 120 is caused to transmit the channel quality threshold in at least one of: RRC dedicated signaling; broadcast signaling; MBS traffic channel, MTCH; or MBS control channel, MCCH.

FIG. 6 shows a flowchart of an example method 600 implemented at a network device (for example, the second network device 160) in accordance with some embodiments of the present disclosure. For the purpose of discussion, the method 600 will be described from the perspective of the second network device 160 with reference to FIG. 1.

At 610, the second network device 160 obtains a channel quality threshold for a terminal device 110 to determine whether to disable transmission by the terminal device 110 of QoE reporting data for a service. At 620, the network device 160 transmits the channel quality threshold to a first network device 120.

In some embodiments, the service is a Multicast Broadcast Service, MBS. In some embodiments, the second network device 160 may obtain a channel quality threshold by receiving the channel quality threshold from an OAM entity. In some embodiments, the second network device 160 may obtain a channel quality threshold by determining the channel quality threshold based on statistic information received from MCE.

In some embodiments, an apparatus capable of performing any of operations of the method 400 (for example, the terminal device 110) may include means for receiving a channel quality threshold from a first network device 120; means for determining whether a channel quality level associated with a service is greater than or equal to the threshold; and means for based on determining that the quality level is greater than or equal to the channel quality threshold level, disable transmission of QoE reporting data for the service to the first network device 120.

In some embodiments, the apparatus further comprises: means for based on determining that the channel quality level is lower than the channel quality threshold, the terminal device 110 may perform first QoE measurement for the service to obtain first QoE reporting data; and transmit the first QoE reporting data to the first network device 120.

In some embodiments, at least one of the following is performed in an idle mode or an inactive mode of the apparatus: the apparatus may determine whether the channel quality level associated with the service is greater than or equal to the channel quality threshold; the apparatus may disable transmission of QoE reporting data for the service to the first network device; and the apparatus may perform the first QoE measurement.

In some embodiments, the apparatus further comprises means for transmitting the first QoE reporting data in a connected mode of the terminal device via an access stratum of the device.

In some embodiments, the service is a Multicast Broadcast Service, MBS.

In some embodiments, the means for disabling the transmission of the QoE reporting data for the service comprises: means for transmitting, from an access stratum of the terminal device to an application layer of the apparatus, an indication that is indicative of stopping QoE measurement for the service at the application layer, or that is indicative of stopping transmission of QoE reporting data for the service from the application layer to the access stratum.

In some embodiments, the means for disabling the transmission of the QoE reporting data for the service comprises at least one of: means for stopping, at the application layer, QoE measurement for the service based on receiving, from the access stratum, the indication that is indicative of stopping QoE measurement for the service; or means for performing, at the application layer, QoE measurement for the service and stopping transmitting QoE reporting data for the service from the application layer to the access stratum based on receiving, from the access stratum, the indication that is indicative of stopping transmission of QoE reporting data for the service.

In some embodiments, the apparatus further comprises means for performing QoE measurement for the service in an application layer of the terminal device 110, and to transmit QoE reporting data from the application layer to an access stratum of the terminal device 110, and means for disabling the transmission of QoE reporting data for the service by discarding, at the access stratum, QoE reporting data for the service received from the application layer.

In some embodiments, the channel quality threshold is one of a plurality of channel quality thresholds received from the first network device. In some embodiments, the channel quality threshold is one of a plurality of channel quality thresholds received from the first network device. In some embodiments, a channel quality threshold of the plurality of channel quality thresholds is specific to a serving or camping cell of the terminal device, and at least one other channel quality threshold of the plurality of channel quality thresholds is specific to at least one respective neighbor cell.

In some embodiments, a channel quality threshold of the plurality of channel quality thresholds is configured for at least one measurement configuration, the at least one measurement configuration being associated with at least one respective service.

In some embodiments, a channel quality threshold of the plurality of channel quality thresholds is configured for the idle mode, and wherein another channel quality threshold of the plurality of channel quality thresholds is configured for the inactive mode.

In some embodiments, the channel quality level is determined based on a reference signal transmitted in Physical Downlink Shared Channel or Physical Downlink Control Channel that carries the service, and wherein the channel quality level comprises at least one of Reference Signal Receiving Power, RSRP, Reference Signal Receiving Quality, RSRQ, or Received Signal Strength Indicator, RSSI.

In some embodiments, the apparatus may further include means for receiving the channel quality threshold in at least one of: RRC dedicated signaling; broadcast signaling; MBS traffic channel, MTCH; or MBS control channel, MCCH.

In some embodiments, the apparatus further comprises means for performing other steps in some embodiments of the method 400. In some embodiments, the means comprises at least one processor and at least one memory storing instructions that, when executed by the at least one processor, cause the performance of the apparatus.

In some embodiments, an apparatus capable of performing any of the method 500 (for example, the first network device 120) may include means for performing the respective steps of the method 500. The means may be implemented in any suitable form. For example, the means may be implemented in a circuitry or software module.

In some embodiments, the apparatus may further include means for obtaining a channel quality threshold for a terminal device to determine whether to disable transmission by the terminal device of QoE reporting data for a service; and means for transmitting the channel quality threshold to the terminal device.

In some embodiments, the service is a Multicast Broadcast Service, MBS. In some embodiments, the channel quality threshold is one of a plurality of channel quality thresholds transmitted to the terminal device. In some embodiments, a channel quality threshold of the plurality of channel quality thresholds is specific to a serving or camping cell of the terminal device, and at least one other channel quality threshold of the plurality of channel quality thresholds is specific to at least one respective neighbor cell. In some embodiments, the first network device is further caused to receive the at least one other channel quality threshold from a second network device.

In some embodiments, a channel quality threshold of the plurality of channel quality thresholds is configured for at least one measurement configuration, the at least one measurement configuration being associated with at least one respective service.

In some embodiments, a channel quality threshold of the plurality of channel quality thresholds is configured for an RRC idle mode of the terminal device, and wherein another channel quality threshold of the channel quality plurality of thresholds is configured for an RRC inactive mode of the terminal device.

In some embodiments, the means for obtaining the channel quality threshold may include means for receiving the channel quality threshold from an OAM entity.

In some embodiments, the means for obtaining the channel quality threshold may include means for determining the channel quality threshold based on statistic information received from a MCE.

In some embodiments, the means for transmitting the channel quality threshold comprises means for transmitting the channel quality threshold in at least one of: RRC dedicated signaling; broadcast signaling; MBS traffic channel, MTCH; or MBS control channel, MCCH.

In some embodiments, the apparatus further comprises means for performing other steps in some embodiments of the method 500. In some embodiments, the means comprises at least one processor and at least one memory storing instructions that, when executed by the at least one processor, cause the performance of the apparatus.

In some embodiments, an apparatus capable of performing any of the method 600 (for example, the second network device 160) may include means for obtaining a channel quality threshold for a terminal device to determine whether to disable transmission by the terminal device of QoE reporting data for a service; and means for transmitting the channel quality threshold to a first network device. The means may be implemented in any suitable form. For example, the means may be implemented in a circuitry or software module.

In some embodiments, the service is a Multicast Broadcast Service, MBS.

In some embodiments, the means for obtaining the channel quality threshold may include means for receiving the channel quality threshold from an OAM entity. In some embodiments, the means for obtaining the channel quality threshold may include means for determining the channel quality threshold based on statistic information received from a MCE.

In some embodiments, the apparatus further comprises means for performing other steps in some embodiments of the method 600. In some embodiments, the means comprises at least one processor and at least one memory storing instructions that, when executed by the at least one processor, cause the performance of the apparatus.

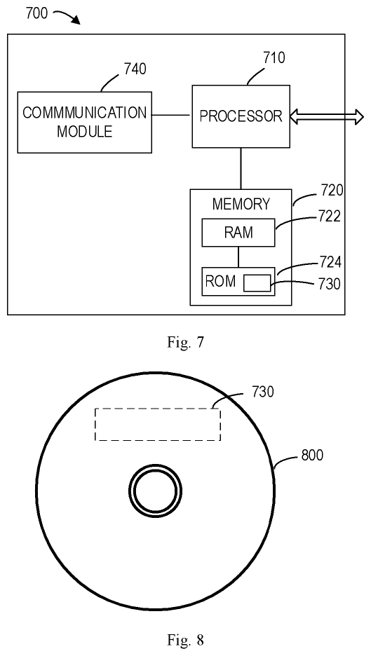

FIG. 7 is a simplified block diagram of a device 700 that is suitable for implementing embodiments of the present disclosure. The device 700 may be provided to implement the communication device, for example the terminal device 110 or the network device 120 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A program 730 includes executable instructions that are executed by the associated processor 710. The program 730 may be stored in the ROM 724. The processor 710 may perform any suitable actions and processing by loading the program 630 into the RAM 722.

The embodiments of the present disclosure may be implemented by means of the program so that the device 600 may perform any process of the disclosure as discussed with reference to FIGS. 2 to 6. The embodiments of the present disclosure may also be implemented by hardware or by a combination of software and hardware.

In some embodiments, the program 730 may be tangibly contained in a readable storage medium which may be included in the device 700 (such as in the memory 720) or other storage devices that are accessible by the device 700. The device 700 may load the program 730 from the storage medium to the RAM 722 for execution. The storage medium may include any types of tangible non-volatile storage, such as ROM, EPROM, a flash memory, a hard disk, CD, DVD, and the like. FIG. 8 shows an example of the storage medium 800 in form of CD or DVD. The storage medium has the processor instructions 730 stored therein.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one program product tangibly stored on a non-transitory readable storage medium. The program product includes executable instructions, such as those included in program modules, being executed in a device on a target real or virtual processor, to carry out process 200 or 300, the method 400, 500 or 600 as described above with reference to FIG. 2 to FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the program codes or related data may be carried by any suitable carrier to enable the device, apparatus or processor to perform various processes and operations as described above. Examples of the carrier include a signal, readable storage medium, and the like.

The readable medium may be a readable signal medium or a readable storage medium. A readable storage medium may include but not limited to an electronic, magnetic, optical, electromagnetic, infrared, or semiconductor system, apparatus, or device, or any suitable combination of the foregoing. More specific examples of the readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-35. (canceled)

36. An apparatus comprising at least one processor; and at least one memory storing instructions that, when executed by the at least one processor, cause the apparatus to:
receive a channel quality threshold from a first network device;
determine whether a channel quality level associated with a service is greater than or equal to the channel quality threshold; and
based on determining that the channel quality level is greater than or equal to the channel quality threshold, disable transmission of quality of experience (QoE) reporting data for the service to the first network device.

37. The apparatus of claim 36, wherein the apparatus is further caused to:
based on determining that the channel quality level is lower than the channel quality threshold, perform first QoE measurement for the service to obtain first QoE reporting data; and
transmit the first QoE reporting data to the first network device.

38. The apparatus of claim 36, wherein at least one of the following is performed in an idle mode or an inactive mode of the apparatus:
determining whether the channel quality level associated with the service is greater than or equal to the channel quality threshold;
disabling transmission of QoE reporting data for the service to the first network device; or
performing the first QoE measurement.

39. The apparatus of claim 36, wherein the apparatus is further caused to transmit the first QoE reporting data by:
transmitting, via an access stratum of the apparatus, the first QoE reporting data in a connected mode of the apparatus.

39. The apparatus of claim 36, wherein the service is a Multicast Broadcast Service (MBS).

41. The apparatus of claim 36, wherein the apparatus is further caused to disable transmission of QoE reporting data for the service by:
transmitting, from an access stratum of the apparatus to an application layer of the apparatus, an indication that is indicative of stopping QoE measurement for the service at the application layer, or that is indicative of stopping transmission of QoE reporting data for the service from the application layer to the access stratum.

42. The apparatus of claim 41, wherein the apparatus is further caused to disable transmission of QoE reporting data for the service by at least one of:
stopping, at the application layer, QoE measurement for the service based on receiving, from the access stratum, the indication that is indicative of stopping QoE measurement for the service; or
performing, at the application layer, QoE measurement for the service and stopping transmitting QoE reporting data for the service from the application layer to the access stratum based on receiving, from the access stratum, the indication that is indicative of stopping transmission of QoE reporting data for the service.

43. The apparatus of claim 36, wherein the apparatus is further caused to perform QoE measurement for the service in an application layer of the apparatus, and to transmit QoE reporting data from the application layer to an access stratum of the apparatus, and wherein the apparatus is further caused to disable the transmission of QoE reporting data for the service by discarding, at the access stratum, QoE reporting data for the service received from the application layer.

44. The apparatus of claim 36, wherein the channel quality threshold is one of a plurality of channel quality thresholds received from the first network device.

45. The apparatus of claim 44, wherein a channel quality threshold of the plurality of channel quality thresholds is specific to a serving or camping cell of the apparatus, and at least one other channel quality threshold of the plurality of channel quality thresholds is specific to at least one respective neighbor cell.

46. The apparatus of claim 44, wherein a channel quality threshold of the plurality of channel quality thresholds is configured for at least one measurement configuration, the at least one measurement configuration being associated with at least one respective service.

47. The apparatus of claim 44, wherein a channel quality threshold of the plurality of channel quality thresholds is configured for an idle mode of the apparatus, and wherein another channel quality threshold of the plurality of channel quality thresholds is configured for an inactive mode of the apparatus.

48. The apparatus of claim 36, wherein the channel quality level is determined based on a reference signal transmitted in Physical Downlink Shared Channel or Physical Downlink Control Channel that carries the service, and wherein the channel quality level comprises at least one of Reference Signal Receiving Power (RSRP), Reference Signal Receiving Quality (RSRQ), or Received Signal Strength Indicator (RSSI).

49. The apparatus of claim 36, wherein the apparatus is caused to receive the channel quality threshold in at least one of:
Radio Resource Control (RRC) dedicated signaling;
broadcast signaling;
MBS traffic channel (MTCH); or
MBS control channel (MCCH).

50. An apparatus comprising at least one processor; and at least one memory storing instructions that, when executed by the at least one processor, cause the apparatus to:
obtain a channel quality threshold for a terminal device to determine whether to disable transmission by the terminal device of quality of experience (QoE) reporting data for a service; and
transmit, to the terminal device, the channel quality threshold.

51. The apparatus of claim 50, wherein the service is a Multicast Broadcast Service (MBS).

52. The apparatus of claim 50, wherein the channel quality threshold is one of a plurality of channel quality thresholds transmitted to the terminal device.

53. The apparatus of claim 52, wherein a channel quality threshold of the plurality of channel quality thresholds is specific to a serving or camping cell of the terminal device, and at least one other channel quality threshold of the plurality of channel quality thresholds is specific to at least one respective neighbor cell of the serving or camping cell.

54. The apparatus of claim 52, wherein a channel quality threshold of the plurality of channel quality thresholds is configured for an idle mode of the terminal device, and wherein another channel quality threshold of the channel quality plurality of thresholds is configured for an inactive mode of the terminal device.

55. A method comprising:
receiving, at a terminal device, a channel quality threshold from a first network device;
determining whether a channel quality level associated with a service is greater than or equal to the channel quality threshold; and
based on determining that the channel quality level is greater than or equal to the channel quality threshold, disabling transmission of quality of experience (QoE) reporting data for the service to the first network device.
